(19) United States
(12) Patent Application Publication
(10) Pub. No.: US 2012/0324004 A1
(43) Pub. Date: Dec. 20, 2012

(54) SYSTEMS AND METHODS FOR ANALYZING SOCIAL NETWORK USER DATA

(76) Inventors: Hieu Khac Le, Champaign, IL (US); William P. Tai, Menlo Park, CA (US); Nam Pham, Champaign, IL (US); Ngon Pham Huu, Ho Chi Minh City (VN); Sebo Dapper, Champaign, IL (US); Barak Berkowitz, Palo Alto, CA (US)

(21) Appl. No.: 13/454,826

(22) Filed: Apr. 24, 2012

Related U.S. Application Data
(60) Provisional application No. 61/486,158, filed on May 13, 2011.

(51) Int. Cl. G06F 15/16

(52) U.S. Cl. 709/204

(57) ABSTRACT

One embodiment of a method for analyzing the social network data of one or more users can retrieving from a server data indicative of a user interest profile; determining an initial interest set from the user interest profile using a social graph function; determining a user network influence score including both an influence score for a user and one or more user connections; and generating a final user interest profile in response to an iterative combination of the initial interest set and the user network influence score such that in response to a query, the final user interest profile is returned. Preferably, the preferred method returns the final user interest profile from a central computer to a second computer associated with a third party initiating the query.

### CLAIM OF PRIORITY

The present application claims priority to U.S. Provisional Patent Application Ser. No. 61/486,158 entitled “Systems and Methods for Analyzing Social Network User Data” and filed on 13 May 2011, the entirety of which is incorporated herein by this reference.

### TECHNICAL FIELD

This invention relates generally to the field of computer-based analytics, and more particularly to the field of determining one or more interests of a social network user.

### BACKGROUND AND SUMMARY

Preferred embodiments of the present invention can include a system, method, computer program product or apparatus configured to determine, infer, interpolate or analyze one or more interests of an individual based at least in part upon his or her self-description and/or user-generated content and at least in part upon one or more self-descriptions and/or sharing content of one or more additional users in his or her social and/or subscription network. In the preferred embodiments, the methods and systems described herein can be configured to compute, calculate, generate, and/or determine both an interest set of any particular user as well as an absolute or relative influence of any particular user. The preferred embodiments of the present invention can be readily adapted for use by third party advertising or marketing agency. For example, such a third party can utilize one or more aspects of the preferred systems and methods to determine who is interested in its products/services, who its most influential social network spokespeople are, and/or the relative pervasiveness and/or reach of any social media marketing campaign. Aspects of the preferred embodiments can identify: individual user profiles by interest category; individual interests by user profile; relative or absolute influence within an interest category; and/or relative or absolute influence within a social networking service or sub-network of the social networking service. Other variations, features, and aspects of the systems and methods of the preferred embodiments are described in detail below with reference to the appended drawings.

### BRIEF DESCRIPTION OF THE FIGURES

FIG. 1 is a flowchart depicting a method for analyzing the social network data of a user in accordance with a preferred embodiment of the present invention.

FIGS. 2-7 are flowcharts depicting variations of the preferred method for analyzing the social network data of a user.

FIG. 8 is a flowchart depicting a method for analyzing the social network data of a user in accordance with another preferred embodiment of the present invention.

FIG. 9 is a schematic block diagram of a system or operating environment for analyzing the social network data of a user in accordance with another preferred embodiment of the present invention.

FIG. 10 is a schematic block diagram of an example interest graph usable the systems and methods for analyzing the social network data of a user in accordance with the preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### Preferred Methods

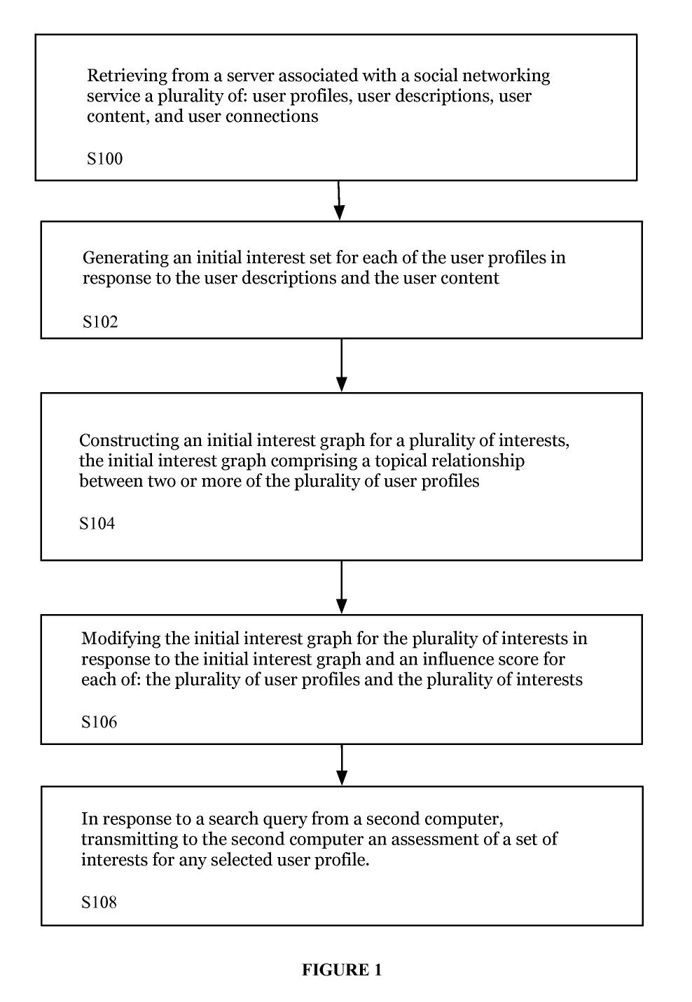

As shown in FIG. 1, one preferred embodiment of a method for analyzing the social network data of one or more users can include retrieving from a server associated with a social networking service: a plurality of: user profiles, user descriptions, user content, and user connections in block S100. The first preferred method can further include generating an initial interest set for each of the user profiles in response to the user descriptions and the user content in block S102, and constructing an initial interest graph for a plurality of interests, wherein the initial interest graph can include a topical relationship between two or more of the plurality of user profiles in block S104. The first preferred method can further include modifying the initial interest graph for the plurality of interests in response to the initial interest graph and an influence score for each of: the plurality of user profiles and the plurality of interests in block S106; and in response to a search query from a second computer associated with a searcher, transmitting to the second computer an assessment of a set of interests and the influence score for any selected user profile in block S108.

One or more of the aforementioned blocks and/or actions are preferably performed by and/or at a first computer. The first computer and/or second computer can include a personal computer, a laptop computer, a tablet computer, a smart phone, a personal digital assistant, a server, a server cluster, a virtual machine, a cloud-based machine instance, or any suitable plurality, permutation, or combination thereof. In one example implementation of the first preferred method, the first computer is a server, a server cluster, a virtual machine, or a cloud-based machine instance and the second computer is one of a personal computer, a laptop computer, a tablet computer, a smart phone, or a personal digital assistant. The first preferred method can function to provide useful, valuable, and marketable data concerning a user's interests and social network influence determined in response to analysis of the user's associated user profile.

As shown in FIG. 1, the first preferred method can include block S100, which recites retrieving from a server associated with a social networking service a plurality of: user profiles, user descriptions, user content, and user connections. Block S100 preferably functions to access, download, capture, receive, mine, scrape, and/or retrieve data indicative of a user identity, user social network, and/or user behavior, from some or all of which a user's interests can be inferred as described below. As used herein, a social networking service can include social networking websites, business networking websites, bogs, personal websites, and any other suitable Internet accessible database, domain, or subdomain on which a user can connect to other users. Example social networking services can include Google+, Facebook, Twitter, LinkedIn, Pinterest, tumblr, blogspot, Wordpress, and/or Myspace. A user can include any natural person or artificial entity, such as a business association, government, non-profit organization, team, franchise, brand, and/or political party. A suitable user profile can include any identifying name, moniker, or handle usable in identifying the user within the bounds of the social networking service. A suitable user description can include any biographical statements or lists that characterize the user and can be indicative of the declared interests of the user. Suitable user content can include any post, comment, blog, tweet, retweet, and/or hyperlink that further characterize the use and can be indicative of detectable interests of the user. Suitable user connections can include a social graph representation of a user's relationship with other users in the social networking service. Suitable user connections can include for example one or more of the following relationships: a follower, a following, a friend and self. As an example, user A is a follower of user B if A chooses to subscribe to the content generated by B. Conversely, B can have a following that includes at least A. If users A and B are mutual followers and thus part of each other's following, then A and B can be classified as friends. A user can have a relationship of self with himself or herself, as well as with himself/herself and an associated company, team or organization. The user's connections can be indicative of categories or objective statements of a user's relationship to other users, from which all of the users' mutual interests can be inferred as follows.

As shown in FIG. 1, the first preferred method can further include block S102, which recites generating an initial interest set for each of the user profiles in response to the user descriptions and the user content. Block S102 preferably functions to compile, calculate, determine, create, and/or generate a quantitative or qualitative assessment of each of the users' respective interests at least in response to each user's description and content. Preferably, an ontology of keywords, phrases, images, videos, hyperlinks, or other suitable files, characters, or data is used to create the initial interest set. One example implementation of the first preferred method can include creating a database or interest matrix having a collection of pairs having a keyword representing an interest. For example, the user profile “http://twitter.com/a_soccer_lover” can be mapped to a set of keywords such as: “soccer; football; travel; Europe.” Optionally or additionally, the first preferred method can remove stop words (such as definite and indefinite articles) and recognize compound words (such as San Francisco and social media). Similarly, the example implementation of the first preferred method can examine user content for the same types of information including keywords, phrases, images, videos, hyperlinks, or other suitable files, characters, or data is used to create the initial interest set. Thus for example the user content the user content “I love Real Madrid” can be mapped to a set of keywords such as: “soccer; football; travel; Europe.” In alternatives to the first preferred method, block S102 can include generating the initial interest set according to any other suitable model, mode, or mapping algorithm. Those of skill in the art will readily appreciate that the initial interest set for each of the user profiles is a dynamic data set that evolves with each of the user's interests, as defined at least partially by their user descriptions and user content.

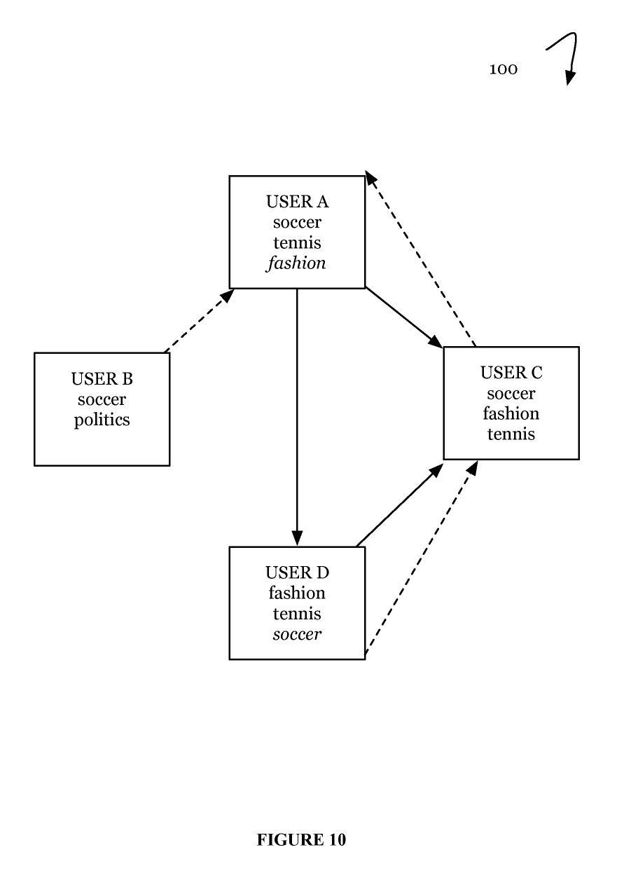

As shown in FIG. 1, the first preferred method can further include block S104, which recites constructing an initial interest graph for a plurality of interests, wherein the initial interest graph can include a topical relationship between two or more of the plurality of user profiles. Block S104 preferably functions to define, create, compute, and/or create a mathematical relationship or construct between the various users in the social networking service that defines the user relationships at least in part by their shared interests. Preferably, the initial interest graph can include a matrix, map, set, or other suitable mathematical relationship that defines how users within the social network are linked to one another through shared interests. The plurality of interests can include any suitable number of interests, although preferably the plurality of interests is limited to a finite number of possible interests so as to prohibit infinite use of the first computer's computational resources. As an example, FIG. 10 illustrates an interest graph 100 depicting various relationships between four users (A, B, C, D) based in part upon their non-exclusively shared interests (soccer, tennis, politics, fashion, etc.). As shown in FIG. 10, solid lines can indicate a friend/follower/followee relationship defined with the social networking service based upon the users' respective interests, while phantom lines can indicate an inferred relationship and/or interest on the part of the receiver of the phantom arrow. As shown, user A is interested in soccer and tennis; user C is interested in soccer, fashion, and tennis; and user D is interested in fashion and tennis. As described in greater detail below, because user A follows both users C and D, the preferred method can optionally infer that user A is interested in fashion as well, even though such an interest was not readily discernable from user A's profile or content. Similarly, since user D is followed by both users A and C, the first preferred method can infer that user D is likely interested in soccer, as user D's two followers share that as a top interest. Those of skill in the art will appreciate that block S104 can be performed on any suitable number of users (nodes) in the social networking service, yielding extremely large permutations of possible interest graphs for use in the first preferred method.

As shown in FIG. 1, the first preferred method can further include block S106, which recites modifying the initial interest graph for the plurality of interests in response to the initial interest graph and an influence score for each of: the plurality of user profiles and the plurality of interests. Block S106 preferably functions to automatically update, alter, amend, rectify, and/or modify the initial interest graph at least in part due to a change in the relative influence and/or interest/s of one or more of the user profiles representing the nodes in the initial interest graph. Preferably, block S106 can further function to economize and/or optimize the size of the global initial interest graph by selecting a predetermined or finite number of interests to consider. Referring again to FIG. 10, the initial interest graph 100 can be updated such that interests are inferred (along phantom arrows) based in part upon the user members in the initial interest graph and their relative influence score/s.

As shown in FIG. 10, both users A and C are followers of user D, who is interested in tennis. If user D is a relatively influential user with respect to that interest, then block S106 functions in part to determine that user D's followers are very interested in tennis. Likewise, if user D is a famous tennis player, then the first preferred method can infer that user A will also have an interest in fashion because users C and D are interested in fashion, and at least user D projects a large amount of influence within the social networking service due to his or her fame. Likewise, if user A is a famous and/or otherwise influential soccer player, then block S106 can further include modifying the initial interest graph such that user B should or could be connected to user A based upon their common interest in soccer and user A's relative fame and/or influence. As an example, if user A is a famous soccer player, user D is a famous tennis player, and user C is a sports and lifestyle magazine, then block S106 can function at least in part to note that user A is likely interested in fashion and user D is interested in soccer through their mutual interests and mutual connections to a particularly influential user C.

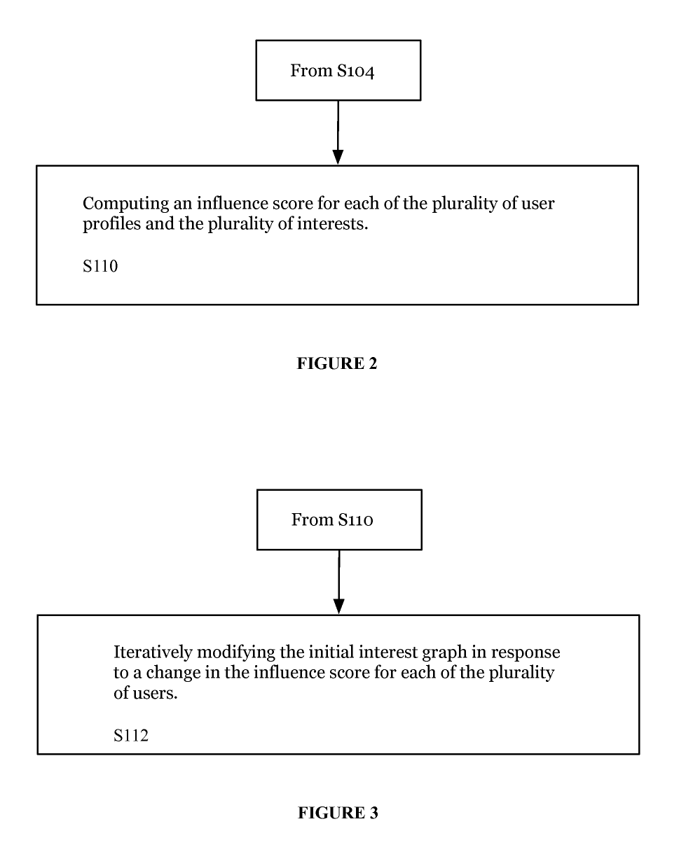

As shown in FIG. 2, one variation of the first preferred method can include block S110, which recites computing an influence score for each of the plurality of user profiles and the plurality of interests. Block S110 preferably functions to determine, calculate, compute, generate, and/or create a relative or absolute measurement of the influence that any particular user in the social networking service has at least within the social networking service. In one alternative implementation of the first preferred embodiment, the influence score can be calculated for each user profile and the plurality of interests within each type of social networking service according to its own social graph. In another alternative implementation of the first preferred embodiment, the influence score can be generally calculated for each user profile and the plurality of interests and applied to any and/or all types of social networking services based upon standardized or normalized metrics of influence. As an example, in the social networking service Twitter, the relative influence of a user profile for any given interest might relate to that user's number of followers, the amount of content relating to the interest, and/or the user's self-described dedication to or expertise in the interest. As an example, as of the date of this document the social networking service Twitter reveals that the soccer player Cristiano Ronaldo has over eight million followers and the athletic brand Nike has over three hundred thousand followers. Accordingly, Ronaldo is likely more influential than Nike in the interest category soccer, although Nike would be more influential in other sporting interest categories. Followers of Ronaldo are likely interested in Nike as a brand, and possibly other Nike branded products; and followers of Nike might also be interested in Nike-sponsored athletes like Ronaldo even if they are not particularly interested in soccer itself. Block S110 therefore preferably functions to score, rank, calculate, and/or determine an influence score for each user profile and each interest. Thus in the example above, Ronaldo will have a higher influence score in the interest “soccer,” while Nike will have a higher influence score in the interests “athletic apparel,” “running,” or “tennis.”

As shown in FIG. 1, the first preferred method can further include block S108, which recites in response to a search query from a second computer, transmitting to the second computer an assessment of a set of interests for any particular selected user profile. Block S108 preferably functions to retrieve, access, compile, present, organize, and/or transmit to a second computer a listing or other type of assessment of the interests of a selected user profile. Preferably, block S108 can be performed in response to a search query of a particular user profile's designation, name, moniker, or handle. Thus a search for the Twitter handle @MrJones will generate a listing, assessment, or other display or presentation of the determined interests of Mr. Jones. As such, a third party user can readily and easily access various topics, brands, individuals, objects, hobbies, products, and/or services in which the user Mr. Jones is interested. As noted above, Mr. Jones' interest is determined at least in part by determining an interest graph for Mr. Jones and determining the influence score of Mr. Jones, those who follow Mr. Jones, and those whom Mr. Jones follows. As an example, if Mr. Jones follows Ronaldo, then in light of Ronaldo's large influence in the interest “soccer,” the block S108 will preferably return that Mr. Jones is also interested in at least soccer. If Mr. Jones also follows other Nike-sponsored athletes, then block S108 preferably returns that Mr. Jones is interested in Nike brand products, even if Mr. Jones himself does not follow Nike or even know that he is interested in the brand or its products.

As shown in FIG. 3, another variation of the first preferred method can include block S112, which recites iteratively modifying the initial interest graph in response to a change in the influence score for each of the plurality of users profiles. Block S112 preferably functions to adjust, alter, amend, change, and/or modify the initial interest graph for any or all user profiles in response to any computed and/or calculated change in the influence score of any or all of the user profiles. Preferably, block S112 modifies the interest graph for any particular user profile based upon changes in the influence of those user profiles being followed. In the example above, Mr. Jones' interest graph can be iteratively modified in response to any changes in the influence scores of those that Mr. Jones follows, i.e., Ronaldo and Nike. As such, if Ronaldo's influence score increases, then Mr. Jones' interest graph is preferably adjusted or modified to illustrate an increased interest in soccer. Likewise, Ronaldo's interest graph and influence score is preferably modified in block S112 in response to any changes in the influence score of the user profiles that he follows. Accordingly, in this variation of the first preferred method, any change in an influence score in the social networking service will propagate through all of the related initial interests graphs, which in turn will cause still further adaptations and/or modifications in the influence score of one or more user profiles in each of the various initial interest graphs, thereby iteratively affecting the interests and influence of each of the plurality of user profiles.

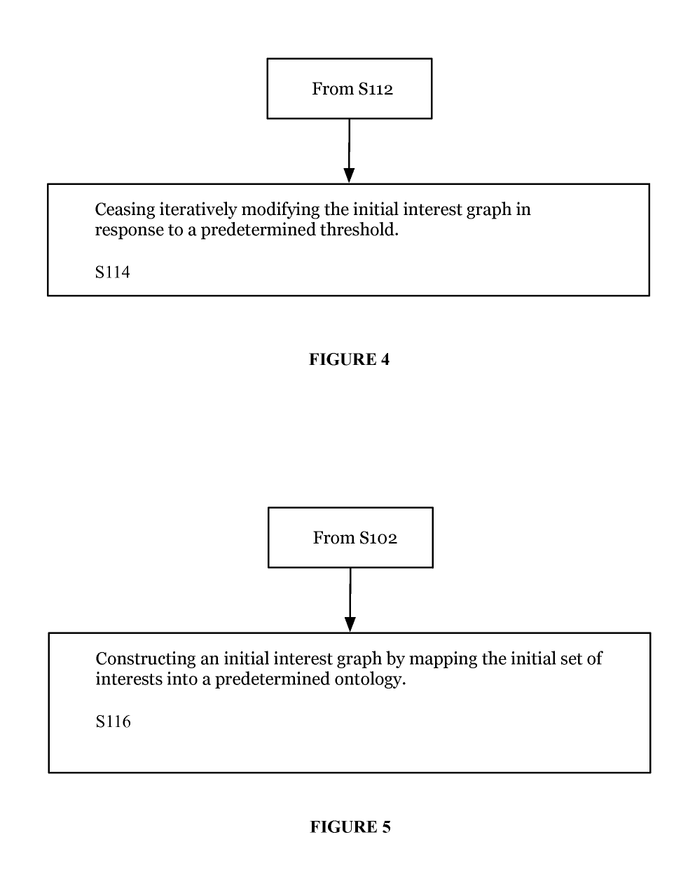

As shown in FIG. 4, another variation of the first preferred method can include block S114, which recites ceasing iteratively modifying the initial interest graph in response to a predetermined threshold. Block S114 preferably functions to limit, restrain, control, and/or cease iteratively modifying the initial interest graph in order to arrive at a steady state level of interest and influence for each user profile within the social networking service. As noted above with reference to FIG. 3, a user profile's interests and influence score can have mutually reinforcing (de-reinforcing) non-linear effects, which can result in a so-called chicken-and-egg scenario in which it is impossible to separate a user profiles interests from the user's influence score or the influence score of the user's connections in the initial interest graph. In other words, a user influences his or her followers, and is influenced by those that he or she follows.

Accordingly, block S114 can optionally include ceasing the iterative modifications of block S112 in response to the predetermined threshold. Example thresholds can include a predetermined duration, a predetermined number of iterations, or a predetermined measure of convergence in the initial interest graph. As an example, operation of the first preferred method on a large set of user profiles (e.g., on the order of millions of user profiles) for a large set of possible interests (e.g., on the order of tens of thousands of interests) can involve several days worth of computation on a substantially large computing platform. Accordingly, block S114 can optionally include ceasing the iterative modifications of block S112 in response to any suitable threshold, such as time (minutes, hours, days, weeks), iterations (ion computations for some value n), and/or a predetermined level of convergence wherein the variation in any suitable number of interests scores is less than a predetermined value (i.e., change in interest score for some number of user profiles is less than an absolute or relative value). Thus for example if block S112 completes one thousand iterations and the top twenty influence scores all settle into ranges of plus or minus five percent, then block S114 can operate to cease any further iterations as a steady state or near steady state value has been reached. Those of skill in the art will readily appreciate that the foregoing example implementation is for illustrative purposes, and that any suitable number of iterations, top influence scores, absolute variance, or percentage variance could readily be configured depending upon the precise application.

As shown in FIG. 5, another variation of the first preferred method can include block S116, which recites constructing an initial interest graph by mapping the initial set of interests into a predetermined ontology. Block S116 preferably functions to create, maintain, and/or monitor the initial interest graph according to a correlation between the initial set of interests and a predetermined ontology that determines the boundaries, existence, meanings, and characteristics of the initial set of interests. The predetermined ontology can include any suitable set or group of topics that are associated in any suitable manner with an interest. The predetermined set of topics are preferably defined by words, phrases, abbreviations, symbols, or any other suitable set or string of alphanumeric characters or codes that represent, denote, or connote an interest. For example, the topics “soccer,” “tennis,” and “fashion” are representative words of an example predetermined ontology that relate to interests in those fields. Similarly, the topics “zizou,” “rafa,” and “#lv” are representative character strings of the example predetermined ontology that relate to interests particular individuals or brands within the aforementioned fields. Those of skill in the art will appreciate from the foregoing discussion that a user's interest in “#lv,” through implementation of the first preferred method, will illustrate that the user is also interested in the field of fashion. The predetermined ontology can include a substantially large yet finite number of topics upon which the initial interest graphs can be constructed. In one variation of the first preferred method, the predetermined ontology can include more than one hundred thousand topics. In other variations of the first preferred method, the predetermined ontology can include any suitable number of topics that are reasonably necessary to generate a sufficient description of the interest profile of a corresponding number of user profiles. In one example implementation of the first preferred method, approximately one hundred thousand topics can be permuted through approximately tens of millions of user profiles to generate the initial interest graph in block S102.

Another variation of the first preferred method can further include distilling a global ontology into the predetermined ontology. As an example, the topic “dog sitting” might technically qualify to be within an initial global ontology in the event there are user profiles indicating an interest in dog sitting. However, if there are relatively few users who share that interest, relatively few users of high influence who share that interest, or any combination thereof, then the first preferred method can include eliminating that particular topic from the ontology in generating the predetermined ontology. Nevertheless, if there are a large number of users with an interest in dog sitting, or any one or more particular individuals of high influence with an interest in dog sitting (e.g., the celebrity dog trainer Cesar Milan), then the topic will survive into the predetermined ontology. In doing so, this variation of the first preferred method functions in part to ensure that: only the topics with a broad interest are analyzed, and/or only the topics with one or more profiles of large influence are analyzed. In one alternative implementation of the first preferred embodiment, distilling a global ontology into the predetermined ontology can include removing any suitable number of topics from the global ontology above or below a selected threshold. For example, the threshold can include an absolute number of topics (e.g., one hundred thousand), a variable number of topics with a predetermined number of interested users, a variable number of topics with a predetermined number of influential users, a variable number of topics with at least one user exceeding a predetermined influence score, or any suitable combination, permutation, or alternative measure of the relative breadth and depth of interest in the topic/s.

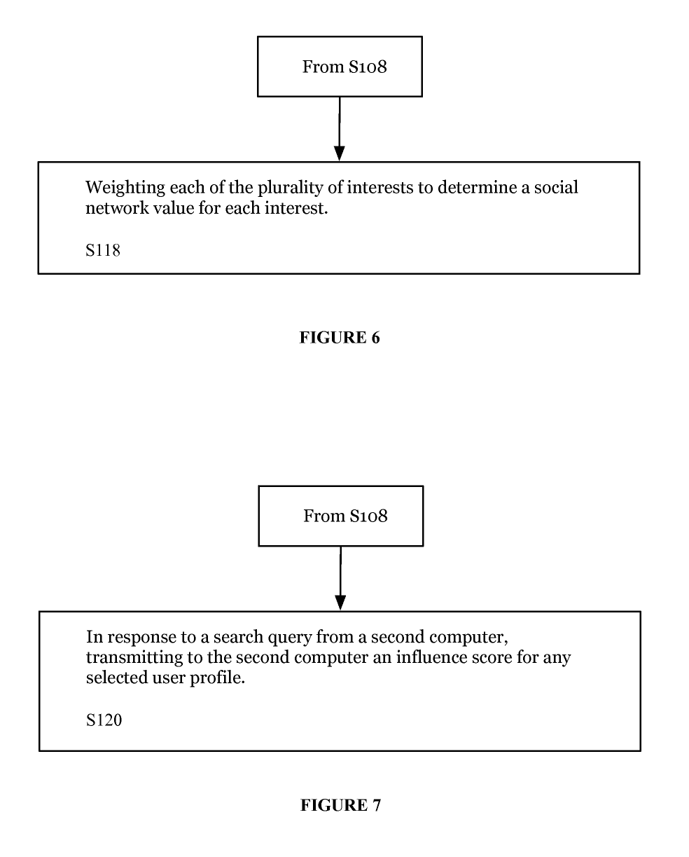

As shown in FIG. 6, another variation of the first preferred method can include block S118, which recites weighting each of the plurality of interests to determine a social network value for each interest. Block S118 preferably functions to calculate, compute, and/or generate a value metric for any one or more interests within the social networking service. Preferably, block S118 can additionally function to determine a relative value of any one or more interests as compared to other interests within the social networking service. As an example, block S118 can include weighting the influence score of a user profile in the initial interest graph. Preferably, block S118 can further include determining an interest score as a weighted sum of all of the influence scores in the user profiles social interest graph. In one example implementation of the first preferred method, block S118 can include one or both of: assigning a higher relative value to the interest in response to a user profile in the initial interest graph having a higher relative influence score; or assigning a lower relative value to the interest in response to a user profile in the initial interest graph having a lower relative influence score. That is, for any interest, the interest score can be represented as the sum of all of the influence score of the interests followings such that the higher the weighted influence score, the higher the interest score for that particular interest.

As shown in FIG. 7, another variation of the first preferred method can include block S120, which recites in response to a search query from a second computer, transmitting to the second computer an influence score for any selected user profile. Block S120 preferably functions to permit a searcher or third party to access the influence score for any selected user profile, thus providing third parties with access to the most/least influential user profiles within any given social networking service. As an example, an advertising or marketing agency can, as a third party searcher, implement one or more aspects of the first preferred method to determine who is interested in its products/services, who its most influential social network spokespeople are, and/or the relative pervasiveness and/or reach of any social media marketing campaign. Aspects of the first preferred method can identify: individual user profiles by interest category; individual interests by user profile; relative or absolute influence within an interest category; and/or relative or absolute influence within a social networking service or sub-network of the social networking service. For example, aspects of the first preferred method can be used to determine individuals interested in “soccer,” the individual interests of an international soccer star, the relative influence of that soccer star within the category of soccer, and/or the relative influence of that soccer star within the entire social network or a sub-network of professional athletes, sponsored athletes, and the like. The example third party marketer can then, using the aforementioned aspects of the first preferred method, objectively and accurately determine whether said international soccer star would be a useful or profitable marketer or cross-marketer of a soccer-related product, i.e., athletic wear, given his or her relative influence, interest graph, and potential reach within the social networking service.

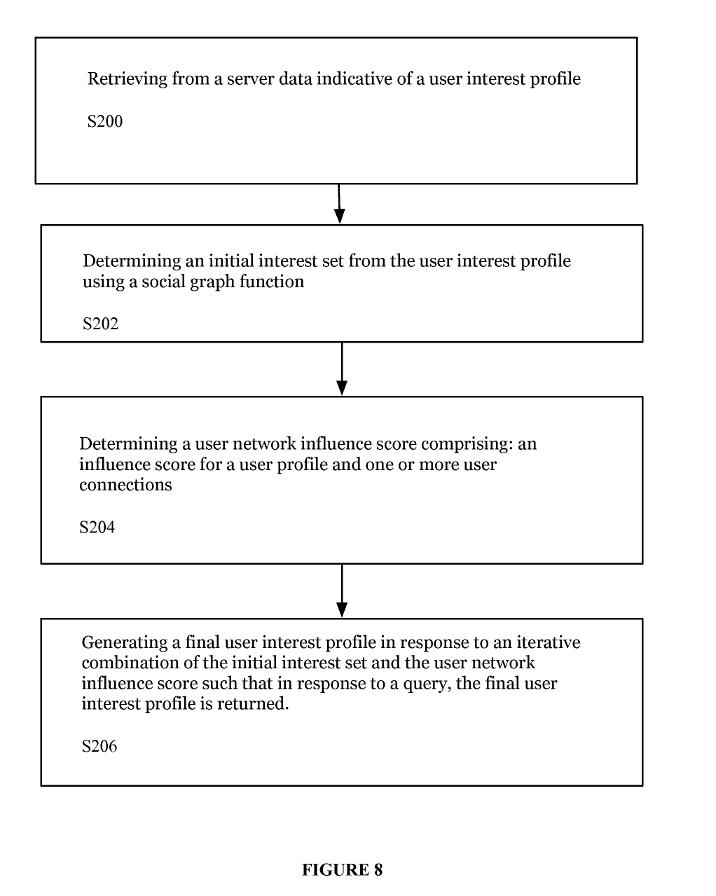

As shown in FIG. 8, a second preferred embodiment of a method for analyzing the social network data of one or more users can retrieving from a server data indicative of a user interest profile in block S200; determining an initial interest set from the user interest profile using a social graph function in block S202; determining a user network influence score including both an influence score for a user and one or more user connections in block S204; and generating a final user interest profile in response to an iterative combination of the initial interest set and the user network influence score such that in response to a query, the final user interest profile is returned in block S206. Preferably, block S206 returns the final user interest profile from the central computer to a second computer associated with a third party initiating the query.

One or more of the aforementioned blocks and/or actions of the second preferred method are preferably performed by and/or at a central computer. The central computer and/or second computer can include a personal computer, a laptop computer, a tablet computer, a smart phone, a personal digital assistant, a server, a server cluster, a virtual machine, a cloud-based machine instance, or any suitable plurality, permutation, or combination thereof. In one example implementation of the second preferred method, the central computer is a server, a server cluster, a virtual machine, or a cloud-based machine instance and the second computer is one of a personal computer, a laptop computer, a tablet computer, a smart phone, or a personal digital assistant. In another example implementation of the second preferred method, the server in block S200 is one or more servers, server clusters, virtual machines, and/or cloud based instances associated with a social networking service. The second preferred method functions to provide useful, valuable, and marketable data concerning a user's interests and social network influence determined in response to analysis of the user's associated user profile.

As shown in FIG. 8, the second preferred method can include block S200, which recites retrieving from a server data indicative of a user interest profile. Block S200 preferably functions to access, download, capture, compile, receive, and/or retrieve data that is representative of a user interest profile, which can include for example one or more aspects of a user profile, a user's social network or social graph, and/or a user's interests. A suitable user interest profile can include for example declared interests of a user and/or detected interests of a user. The declared interests can include a self-declared interest of a user, such as for example a biography, list or other self-generated characterization of the user's interests. The detected interests can include for example user-generated content such as a blog post, comment, tweet, retweet, and/or hyperlink that form a detectable characterization of the user's interests. For example, the user profile “http://twitter.com/a_soccer_lover” can be indicative of a declared interest in soccer, which in turn can be mapped to predetermined ontology of potential interests, such as soccer, travel, Europe, and the like. Likewise an associated tweet or user-generated content such as “I love Real Madrid” can be categorized as a detected interest, and can be also be mapped to a predetermined ontology such as the one noted above.

As shown in FIG. 8, the second preferred method can additionally include block S202, which recites determining an initial interest set from the user interest profile using a social graph function. Block S202 preferably functions to map the data representing the user interest profile into the predetermined ontology in order to determine an initial interest set for any and all users within a given social networking service. In one variation of the second preferred method, the initial interest set can include an initial interest graph that is generated according to a correlation between the initial set of interests and the predetermined ontology that determines the boundaries, existence, meanings, and characteristics of the initial set of interests. The predetermined ontology can include any suitable set or group of topics that are associated in any suitable manner with an interest. The predetermined set of topics are preferably defined by words, phrases, abbreviations, symbols, or any other suitable set or string of alphanumeric characters or codes that represent, denote, or connote an interest. As noted above, the topics “soccer,” “tennis,” and “fashion” are representative words of an example predetermined ontology that relate to interests in those fields. Similarly, the topics “zizou,” “rafa,” and “#lv” are representative character strings of the example predetermined ontology that relate to interests particular individuals or brands within the aforementioned fields. As noted above, the predetermined ontology can include a substantially large yet finite number of topics upon which the initial interest graphs can be constructed. In one variation of the second preferred method, the predetermined ontology can include more than one hundred thousand topics. In other variations of the second preferred method, the predetermined ontology can include any suitable number of topics that are reasonably necessary to generate a sufficient description of the interest profile of a corresponding number of user profiles. In one example implementation of the second preferred method, approximately one hundred thousand topics can be permuted through approximately tens million user profiles to generate the initial interest set in block S202.

As shown in FIG. 8, the second preferred method can further include block S204, which recites determining an influence score including at least an influence score for a user profile and one or more user connections. Block S204 preferably functions to determine, calculate, compute, generate, and/or create a relative or absolute measurement of the influence that any particular user or group of users in the social networking service has at least within the social networking service. In one alternative implementation of the second preferred embodiment, the influence score can be calculated for each user profile and the plurality of interests within each type of social networking service according to its own social graph. In another alternative implementation of the second preferred embodiment, the influence score can be generally calculated for each user profile and the plurality of interests and applied to any and/or all types of social networking services based upon standardized or normalized metrics of influence. In the example noted above, in the social networking service Twitter, the relative influence of a user profile for any given interest might relate to that user's number of followers, the amount of content relating to the interest, and/or the user's self-described dedication to or expertise in the interest. As noted above, as of the date of this document the social networking service Twitter reveals that the soccer player Cristiano Ronaldo has over eight million followers and the athletic brand Nike has over three hundred thousand followers. Accordingly, Ronaldo is likely more influential than Nike in the interest category soccer, although Nike would be more influential in other sporting interest categories. Followers of Ronaldo are likely interested in Nike as a brand, and possibly other Nike branded products; and followers of Nike might also be interested in Nike-sponsored athletes like Ronaldo even if they are not particularly interested in soccer itself. Block S204 therefore preferably functions to score, rank, calculate, and/or determine an influence score for each user profile and each interest and one or more user connections. Thus in the example above, Ronaldo will have a higher influence score in the interest “soccer,” while Nike will have a higher influence score in the interests “athletic apparel,” “running,” or “tennis.”

As shown in FIG. 8, the preferred method can further include block S206, which recites generating a final user interest profile in response to an iterative combination of the initial interest set and the user network influence score such that in response to a query, the final user interest profile is returned. Block S206 preferably functions to provide a third party searcher with a final determination of a user's interests in response to a query relating to one of a user profile or an interest category. Block S206 also preferably functions to modify the initial interest set for any particular user profile based upon changes in the influence of those user profiles being followed. In the example above, Mr. Jones' interest graph can be iteratively modified in response to any changes in the influence scores of those that Mr. Jones follows, i.e., Ronaldo and Nike. As such, if Ronaldo's influence score increases, then Mr. Jones' interest graph is preferably adjusted or modified to illustrate an increased interest in soccer. As noted above, any change in an influence score in the social networking service will propagate through all of the related initial interests sets, which in turn will cause still further adaptations and/or modifications in the influence score of one or more user profiles in each of the various initial interest sets, thereby iteratively affecting the interests and influence of each of the plurality of user profiles.

As noted above with reference to FIG. 3, a user profile's interests and influence score can have mutually reinforcing (de-reinforcing) non-linear effects, which can result in a so-called chicken-and-egg scenario in which it is impossible to separate a user profiles interests from the user's influence score or the influence score of the user's connections in the initial interest graph. In other words, a user influences his or her followers, and is influenced by those that he or she follows. Accordingly, in one variation of the second preferred method, block S206 can optionally include ceasing the iterative combinations of the initial interest set and the user network influence score in response to the predetermined threshold. Example thresholds can include a predetermined duration, a predetermined number of iterations, or a predetermined measure of convergence in the initial interest graph. As noted above, operation of the second preferred method on a large set of user profiles (e.g., on the order of millions of user profiles) for a large set of possible interests (e.g., on the order of tens of thousands of interests) can involve several days worth of computation on a substantially large computing platform. Accordingly, block S206 can optionally include ceasing the iterative combinations in response to any suitable threshold, such as time (minutes, hours, days, weeks), iterations (ion computations for some value n), and/or a predetermined level of convergence wherein the variation in any suitable number of interests scores is less than a predetermined value (i.e., change in interest score for some number of user profiles is less than an absolute or relative value). Those of skill in the art will readily appreciate that the foregoing example implementation is for illustrative purposes, and that any suitable number of iterations, top influence scores, absolute variance, or percentage variance could readily be configured depending upon the precise application.

In another variation of the second preferred system, generating a final user interest profile can additionally include weighting an interest score in a selected topic as a function of the influence of a set of user followings. Preferably weighting an interest score can function as a value metric for any one or more interests within the social networking service and to determine a relative value of any one or more interests as compared to other interests within the social networking service. In this variation of the second preferred embodiment, block S206 can further include weighting the influence score of a user profile in the initial interest graph. Preferably, block S206 can further include determining an interest score as a weighted sum of all of the influence scores in the user profiles social interest graph. In one example implementation of the second preferred method, block S206 can include one or both of: assigning a higher relative value to the interest in response to a user profile in the initial interest graph having a higher relative influence score; or assigning a lower relative value to the interest in response to a user profile in the initial interest graph having a lower relative influence score. As noted above, for any interest the interest score can be represented as the sum of all of the influence score of the interests followings such that the higher the weighted influence score, the higher the interest score for that particular interest.

### Preferred System

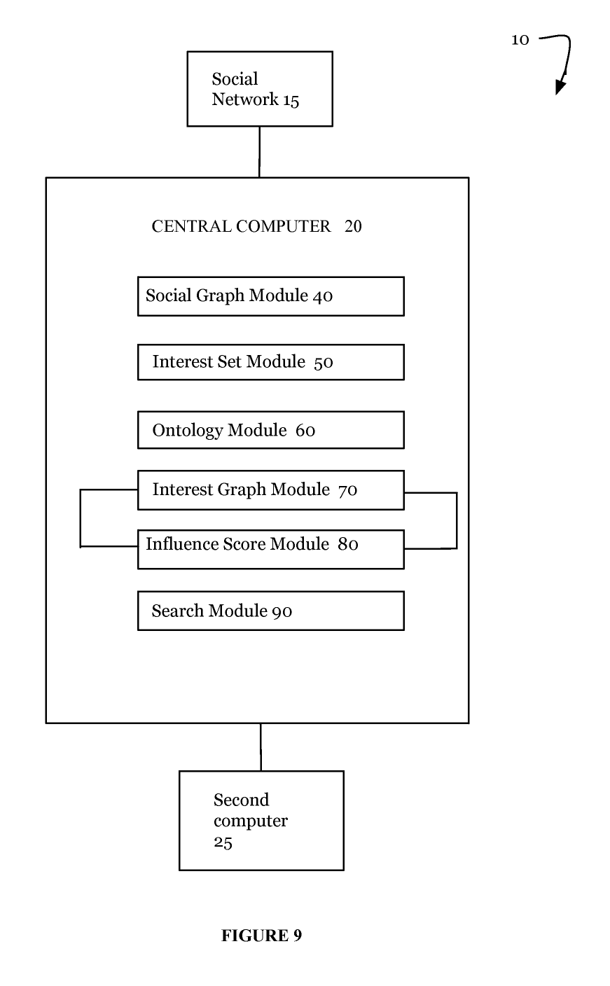

As shown in FIG. 9, a preferred system 10 for analyzing social network user data can include a central computer 20 connected to a social network 15 and at least a second computer 25. The preferred system 10 functions to implement one or more actions of the preferred methods described above, and to provide useful, valuable, and marketable data concerning a user's interests and social network influence determined in response to analysis of the user's associated user profile. A preferred central computer 20 and the preferred second computer 25 can be a personal computer, a laptop computer, a tablet computer, a smart phone, a personal digital assistant, a server, a server cluster, a virtual machine, a cloud-based machine instance, or any suitable plurality, permutation, or combination thereof. In one example implementation of the preferred system 10, the central computer 20 is a server, a server cluster, a virtual machine, or a cloud-based machine instance and the second computer is one of a personal computer, a laptop computer, a tablet computer, a smart phone, or a personal digital assistant. In another example implementation of the preferred system 10, the social network 15 more servers, server clusters, virtual machines, and/or cloud based instances associated with a social networking service. Example social networking services can include Google+, Facebook, Twitter, LinkedIn, Pinterest, tumblr, blogspot, Wordpress, and/or Myspace. A preferred social network 15 can further include a number of users having user profiles, wherein suitable users can be any natural person or artificial entity, such as a business association, government, non-profit organization, team, franchise, brand, and/or political party.

As shown in FIG. 9, the central computer 20 of the preferred system 10 can include one or more modules, each of which can be configured as a distinct server, virtual machine, cloud-based instance, hardware component, firmware component, or special-purpose software component. Alternatively, all of the one or more modules shown in the central computer 20 in FIG. 9 can be integrated into a single server, virtual machine, cloud-based instance, hardware component, firmware component, or special-purpose software component. As shown in FIG. 9, in one variation of the preferred system 10, the central computer 20 can include one or more of: a social graph module 40; an interest set module 50; an ontology module 60; an interest graph module 70, an influence score module 80; and/or a search module 90.

As shown in FIG. 9, in one another variation of the preferred system 10, the central computer 20 can include a social graph module 40. The social graph module 40 preferably functions to receive data from the social network 15 relating to one or more user profiles and to generate, create, establish, map, and/or compute a social graph mathematically representing the various connections between the users in the social network 15. Suitable user connections can include for example one or more of the following relationships: a follower, a following, a friend and self. As an example, user A is a follower of user B if A chooses to subscribe to the content generated by B. Conversely, B can have a following that includes at least A. If users A and B are mutual followers and thus part of each other's following, then A and B can be classified as friends. A user can have a relationship of self with himself or herself, as well as with himself/herself and an associated company, team or organization. The user's connections can be indicative of categories or objective statements of a user's relationship to other users, from which all of the users' mutual interests can be inferred as described herein.

As shown in FIG. 9, in another variation of the preferred system 10, the central computer 20 can include an interest set module 50. The interest set module 40 preferably functions to receive data from the social network is and/or the social graph module 40 and to generate, create, establish, map and/or compute s set of possible interests for each of the one or more users in the social network is. As noted above, the interests can be configured as an initial interest graph and/or an initial interest set, and can include for example declared interests of a user and/or detected interests of a user. The declared interests can include a self-declared interest of a user, such as for example a biography, list or other self-generated characterization of the user's interests. The detected interests can include for example user-generated content such as a blog post, comment, tweet, retweet, and/or hyperlink that form a detectable characterization of the user's interests. For example, the user profile “http://twitter.com/a_soccer_lover” can be indicative of a declared interest in soccer, which in turn can be mapped to predetermined ontology of potential interests, such as soccer, travel, Europe, and the like. Likewise an associated tweet or user-generated content such as “I love Real Madrid” can be categorized as a detected interest, and can be also be mapped to a predetermined ontology such as the one noted above.

As shown in FIG. 9, in another variation of the preferred system 10, the central computer 20 can include an ontology module 60. The ontology module 60 preferably functions to define, establish, monitor, maintain, update, and/or manage a predetermined and/or variable set of ontological entities that describe the interests of the various users in the social network 15. As noted above, the predetermined ontology can include any suitable set or group of topics that are associated in any suitable manner with an interest. The predetermined set of topics are preferably defined by words, phrases, abbreviations, symbols, or any other suitable set or string of alphanumeric characters or codes that represent, denote, or connote an interest. For example, the topics “soccer,” “tennis,” and “fashion” are representative words of an example predetermined ontology that relate to interests in those fields. Similarly, the topics “zizou,” “rafa,” and “#lv” are representative character strings of the example predetermined ontology that relate to interests particular individuals or brands within the aforementioned fields. The ontology module 60 preferably includes a substantially large yet finite number of topics upon which the initial interest graphs can be constructed. In one variation of the preferred system 10, the predetermined ontology can include more than one hundred thousand topics. In other variations of the preferred system, the predetermined ontology can include any suitable number of topics that are reasonably necessary to generate a sufficient description of the interest profile of a corresponding number of user profiles. As noted above, approximately one hundred thousand topics can be permuted through approximately tens of millions of user profiles to generate a suitable initial interest graph.

As shown in FIG. 9, in another variation of the preferred system 10, the central computer 20 can include an interest graph module 70 and an influence score module 80. Preferably, the interest graph module 70 and the influence score module 80 can cooperate through multiple iterations, loops, or a suitable feedback process to calculate, generate, and/or determine a final, searchable interest profile and influence score for any or all users in the social network 15. As noted above with reference to FIGS. 3 and 10, a user profile's interests and influence score can have mutually reinforcing (de-reinforcing) non-linear effects. That is, a user influences his or her followers, and is influenced by those that he or she follows. Accordingly, in another variation of the preferred system 10, the interest graph module 70 and the influence score module 80 can optionally be configured to cease the iterative combinations of the initial interest set and the user network influence score in response to the predetermined threshold. Example thresholds can include a predetermined duration, a predetermined number of iterations, or a predetermined measure of convergence in the initial interest graph. As noted above, operation of the second preferred method on a large set of user profiles (e.g., on the order of millions of user profiles) for a large set of possible interests (e.g., on the order of tens of thousands of interests) can involve several days worth of computation on a substantially large computing platform. The preferred system 10 can be configured to respond to any suitable threshold, such as time (minutes, hours, days, weeks), iterations (ion computations for some value n), and/or a predetermined level of convergence wherein the variation in any suitable number of interests scores is less than a predetermined value (i.e., change in interest score for some number of user profiles is less than an absolute or relative value). As noted above, those of skill in the art will readily appreciate that the foregoing example implementation is for illustrative purposes, and that any suitable number of iterations, top influence scores, absolute variance, or percentage variance could readily be configured depending upon the precise application.

As shown in FIG. 9, another variation of the preferred system 10 can include a search module 90 that preferably functions to interface with the second computer 25. In particular, the search module 90 preferably functions to receive a search input from the second computer 25 in the form of a user profile designation or interest designation (i.e., a selected user profile or any one or more topics in the predetermined ontology); and return to the second computer 25 an appropriate listing, schedule, ranking, or dossier of the user interest profile or the user influence profile. In one example implementation of the preferred system 10, the search module 90 can be at least partially configured as a search engine operable on the central computer 20 such that when a searcher enters the designated search term/s, the search module 90 returns for example a webpage to the second computer 25 displaying the pertinent information regarding the user's interest/s and/or influence.

Aspects of the system and method of the preferred embodiment can be embodied and/or implemented at least in part as a machine configured to receive a computer-readable medium storing computer-readable instructions. The instructions are preferably executed by computer-executable components preferably integrated with the central computer 20, at least one server associated with the social network is, and at least a second computer 25. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with a central computer 20 or user device 30 of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art of computer-based analytics will recognize from the previous detailed description and from the figures and claims, modifications and changes can be made to the preferred embodiments of the invention without departing from the scope of this invention defined in the following claims.

What is claimed is:

1. A method comprising:
at a first computer, retrieving from a server associated with a social networking service:
a plurality of: user profiles, user descriptions, user content, and user connections; and
at the first computer:
generating an initial interest set for each of the user profiles in response to the user descriptions and the user content;
constructing an initial interest graph for a plurality of interests, the initial interest graph comprising a topical relationship between two or more of the plurality of user profiles;
modifying the initial interest graph for the plurality of interests in response to the initial interest graph and an influence score for each of: the plurality of user profiles and the plurality of interests; and
in response to a search query from a second computer associated with a searcher, transmitting to the second computer an assessment of a set of interests and the influence score for any selected user profile.

2. The method of claim 1, further comprising computing an influence score for each of the plurality of user profiles and the plurality of interests.

3. The method of claim 2, further comprising iteratively modifying the initial interest graph in response to a change in the influence score for each of the plurality of users profiles.

4. The method of claim 3, further comprising ceasing iteratively modifying the initial interest graph in response to a predetermined threshold.

5. The method of claim 4, wherein the predetermined threshold comprises one of: a predetermined duration, a predetermined number of iterations, or a predetermined measure of convergence in the initial interest graph.

6. The method of claim 1, wherein constructing an initial interest graph comprises mapping the initial set of interests into a predetermined ontology.

7. The method of claim 6, wherein the predetermined ontology comprises a predetermined set of topics.

8. The method of claim 7, wherein the predetermined set of topics comprises approximately one hundred thousand topics.

9. The method of claim 6, further comprising distilling a global ontology into the predetermined ontology.

10. The method of claim 1, wherein constructing an initial interest graph comprises constructing a subgraph on an existing social graph.

11. method of claim 10, wherein the existing social graph comprises a representation of connections between the plurality of users in the social networking service.

12. The method of claim 1, further comprising weighting each of the plurality of interests to determine a social network value for each interest.

13. The method of claim 12, wherein weighting each of the plurality of interests comprises weighting the influence score of a user profile in the initial interest graph.

14. The method of claim 13, wherein weighting the each of the plurality of interests comprises assigning a higher relative value to the interest in response to a user profile in the initial interest graph having a higher relative influence score.

15. The method of claim 13, wherein weighting the each of the plurality of interests comprises assigning a lower relative value to the interest in response to a user profile in the initial interest graph having a lower relative influence score.

16. The method of claim 1, further comprising in response to a search query from a second computer, transmitting to the second computer an influence score for any selected user profile.

17. A method comprising:
from a central computer, retrieving from a server data indicative of a user interest profile;
determining an initial interest set from the user interest profile using a social graph function;
determining a user network influence score comprising: an influence score for a user profile and one or more user connections; and
generating a final user interest profile in response to an iterative combination of the initial interest set and the user network influence score such that in response to a query, the final user interest profile is returned.

18. method of claim 17, wherein the data indicative of a user interest profile comprises a set of declared interests and a set of detected interests.

19. method of claim 17, wherein the influence score for a user is proportional to a number of followers of the user.

20. The method of claim 17, wherein generating a final user interest profile further comprises weighting an interest score in a selected topic as a function of the influence of a set of user followings.
